(19) United States
(12) Patent Application Publication
(10) Pub. No.: US 2009/0016527 A1
(43) Pub. Date: Jan. 15, 2009

(54) METHOD OF ESTABLISHING A SESSION KEY AND UNITS FOR IMPLEMENTING THE METHOD

(76) Inventors: Jean-Pierre Vigarie, Cesson-Sevigne (FR); Pierre Fevrier, Saint Sulpice La Foret (FR); Franck Baudot, Villa Coublay (FR)

Correspondence Address: STITES & HARBISON PLLC, 1199 NORTH FAIRFAX STREET, SUITE 900, ALEXANDRIA, VA, 22314, US

(21) Appl. No.: 12/064,781

(22) PCT Filed: Aug. 25, 2006
(86) PCT No.: PCT/FR2006/001989

§ 371 Date: Jul. 17, 2008

(30) Foreign Application Priority Data
Aug. 26, 2005 (FR) 0508782

(51) Int. Cl. H04L 9/00

(52) U.S. Cl. 380/259

(57) ABSTRACT

A method of establishing a session key Kₛ for a session between a unit for descrambling scrambled multimedia signals and a removable cryptographic unit, wherein: —one of the units sends (steps 166, 184) the other unit a message containing a received random number, a term α and a signature of the random number and/or the term a produced using a private key K₃ₚᵣ, then—the other unit verifies (steps 168, 192) the signature using a public key K₃ₚᵤ corresponding to the private key (K₃ₚᵣ) and compares (steps 174, 198) the random number received to that sent, and—if the signature is incorrect or if the random number received does not match that sent, then the subsequent steps for establishing the session key are not carried out.

The present invention relates to a method of establishing a session key and to units for implementing the method.

One well-known method of establishing a session key for a session between first and second units is the Diffie Hellman method, also known as the STS (Station-To-Station) protocol.

In the Diffie Hellman method, each unit constructs a term α from which the other unit can establish a session key Kₛ from the following equation:

Kₛ=α^{β} modulo n

where:

β is a random number; and

n is a prime number.

The Diffie Hellman method is vulnerable to interceptor attacks and to replay attacks.

Interceptor attacks are described in detail in the following document:

Douglas Stinson, “Cryptographie Théorie et Pratique” [Cryptography Theory and Practice], International Thomson Publishing France, Paris, 1996 (section 8.4.1).

Replay attacks consist essentially in storing messages sent by the first unit to the second unit and using the stored messages again later to trick the second unit.

Sections 22.1 and 22.2 of “Cryptographie Appliquée” [Applied Cryptography], by BRUCE SCHNEIER, published by WILEY, propose a method of setting up a session key that is resistant to interceptor attacks and to replay attacks. This method works correctly but can lead to executing unnecessary operations in the event of an attack, which is reflected in the unnecessary mobilization of data processing resources in one unit or the other.

This problem of unnecessary mobilization of data processing resources is particularly serious when this kind of method must be used between a descrambler unit and a removable cryptographic unit of a device for receiving scrambled multimedia signals. This is because a conventional descrambler unit and a conventional removable cryptographic unit have limited data processing resources. This is particularly true of the removable cryptographic unit, which takes the form of a microchip card.

The invention therefore aims to solve this problem in the context of devices for receiving scrambled multimedia signals by proposing a method of establishing a session key for a session between a descrambler unit and a removable cryptographic unit that is more economical in terms of data processing resources.

The invention therefore consists in a method of establishing a session key wherein:

a) a first unit draws a random number and sends it to the other unit;

b) the other unit, or second unit, constructs a term α from which the first unit can establish the session key Kₛ from the following equation:

Kₛ=α^{β} mod n

where β is a random number drawn by the first unit and n is a prime number;

c) the second unit sends the first unit a message containing the received random number, the term α, and a signature of the random number and/or of the term α produced using a private key K₃ₚᵣ; then d) the first unit verifies the signature using a public key K₃ₚᵤ corresponding to the private key K₃ₚᵣ and compares the random number received to that sent; and

e) if the signature is incorrect or if the random number received does not match that sent, then the first unit does not proceed to the subsequent steps for establishing the session key.

If an interceptor attack is launched, it is detected during the step d) by verifying the signature and so no further step towards establishing the session key is executed.

If a replay attack is launched, it is also detected during the step d), by comparing the random number sent to that received, and so no further step towards establishing the session key is executed.

Thus the above method economizes on data processing resources compared to the method disclosed in sections 22.1 and 22.2 of the SCHNEIER book. This is because the method described in the SCHNEIER book does not interrupt the process of constructing the session key as soon as an interceptor attack or a replay attack is launched. Session key construction operations are carried out after this happens even though they are not necessary because, when the attack is discovered, the session key that has been constructed or is in the process of being constructed is aborted, for example.

Implementations of this method of establishing a session key can include one or more of the following features:

the steps a) to e) are reiterated a second time with the roles of the first and second units interchanged;

before the steps a) to e), the descrambler unit and the removable cryptographic unit exchange with each other:
+a first public key K₁ₚᵤ;
+a first certificate containing a second public key K₂ₚᵤ and signed using a first private key K₁ₚᵣ corresponding to the first public key K₁ₚᵤ; and
+a second certificate containing a third public key K₃ₚᵤ and signed using a second private key K₂ₚᵣ corresponding to the second public key K₂ₚᵤ, the third public key K₃ₚᵤ corresponding to the private key K₃ₚᵣ used to effect signing during step c); and

the descrambler unit and the removable cryptographic unit each verify the first and second certificates received and proceed to the steps a) to e) only if the descrambler unit and the removable cryptographic unit have been able to verify successfully the authenticity of the first and second certificates each of them has received;

one or both of the units increments a first internal counter as a function of the number of messages sent to and/or received from the other unit and automatically triggers setting up a new session key if the first counter exceeds a predetermined first threshold;

the other unit increments a second internal counter as a function of the same number of messages and automatically causes descrambling of the multimedia signals to be stopped if the second counter exceeds a predetermined second threshold higher than the first threshold;

each of the units increments an internal counter as a function of the number of messages sent and/or received, one or both of the units adds to each message sent to the other unit a redundancy code calculated as a function of the content of the message to be sent and the current value of its internal counter, and the other unit verifies the accuracy of the message received by comparing the redundancy code added to a redundancy code calculated as a function of the content of the message received and the current value of its own internal counter.

Furthermore, these embodiments of the method of establishing a session key have the following advantages:

the exchange of certificates between the descrambler unit and the cryptographic unit ensures, for example, that only manufacturers approved by a trusted authority, i.e. in possession of a first valid certificate, can construct functional descrambler units or photographic units;

triggering establishing a new session key as a function of the value of an internal message counter enables regular modification of the session key, which makes the exchange of information between the two units more secure;

triggering stopping descrambling of multimedia signals if a second internal message counter exceeds a predetermined second threshold is a countermeasure to the use of pirated descrambler units or cryptographic units, which would never trigger establishing a new session key;

using internal message counters in each of the units and using the values of those counters to calculate and verify a redundancy code verifies synchronization of messages exchanged between the two units and helps to make a replay attack more difficult; and

encrypting all messages exchanged between the two units, including certificate exchange and session key updating procedure messages, makes cryptanalysis of the information exchanged more difficult.

The invention also consists in units adapted to be used in the above method of establishing a session key.

The invention can be better understood after reading the following description, which is given by way of example only and with reference to the drawings, in which:

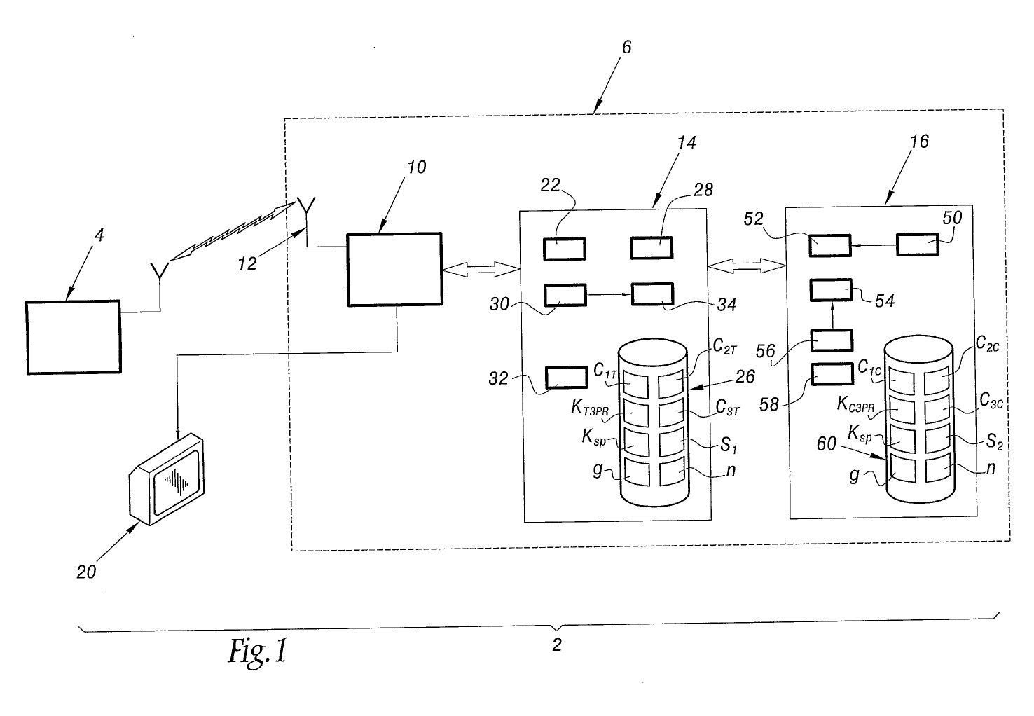

FIG. 1 is a diagrammatic illustration of the architecture of a system for sending scrambled multimedia signals including a device for receiving such signals;

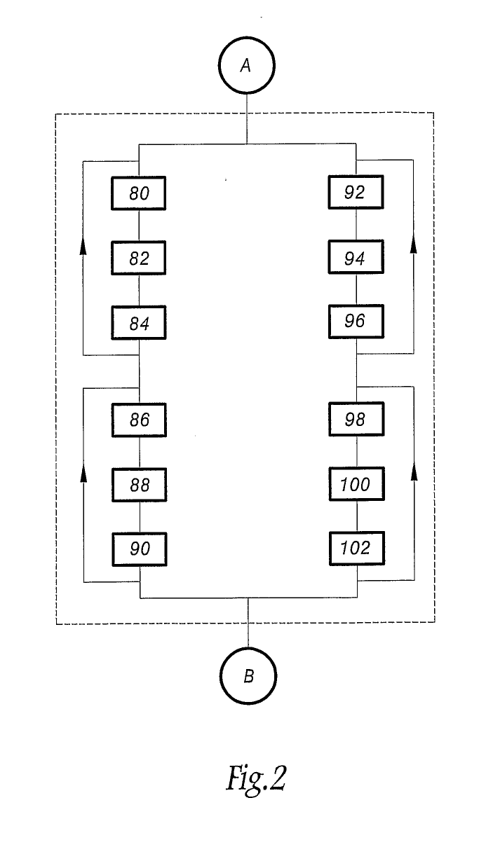

FIG. 2 is a flowchart of a method of establishing cryptographic certificates for the receiver device from FIG. 1;

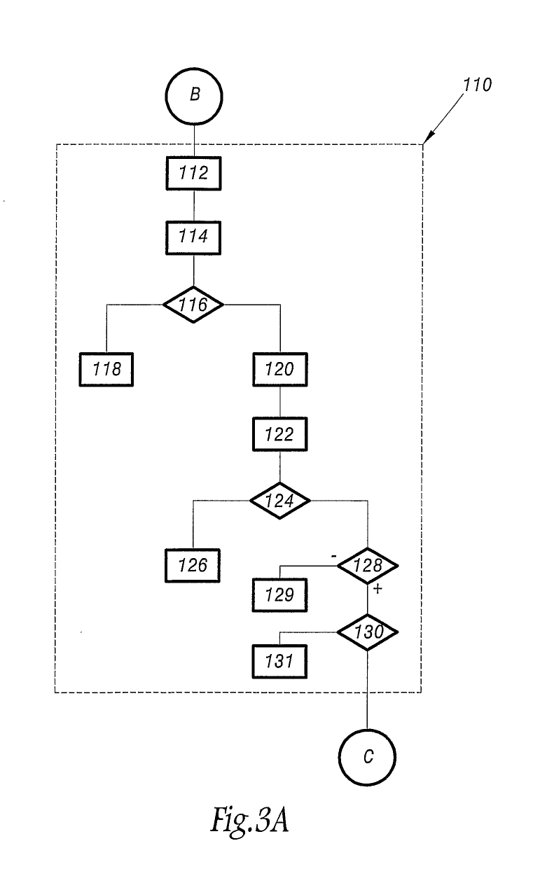

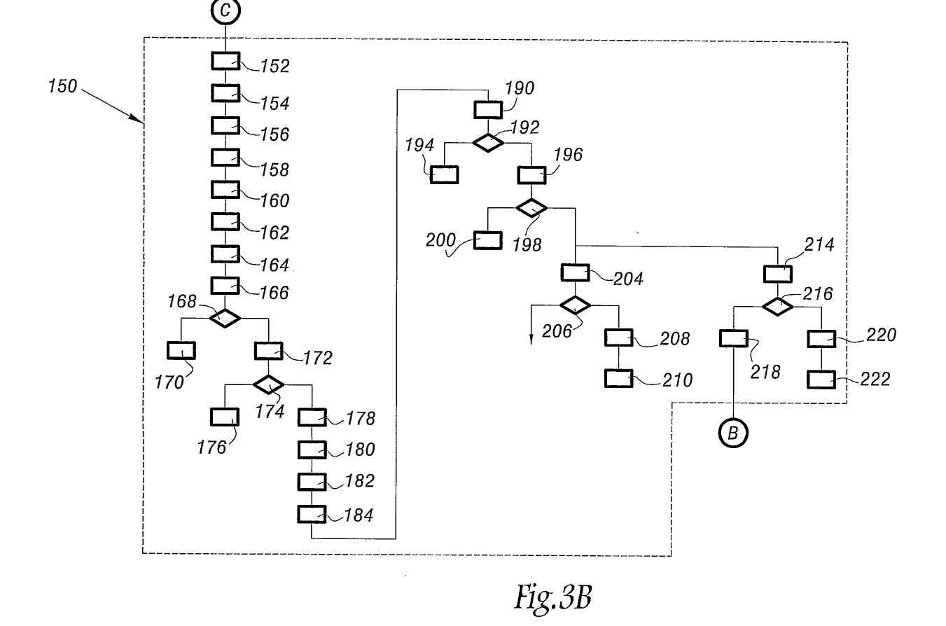

FIGS. 3A and 3B constitute a flowchart of a method of establishing a session key for a session between a descrambler unit and a removable cryptographic unit of the receiver device from FIG. 1; and

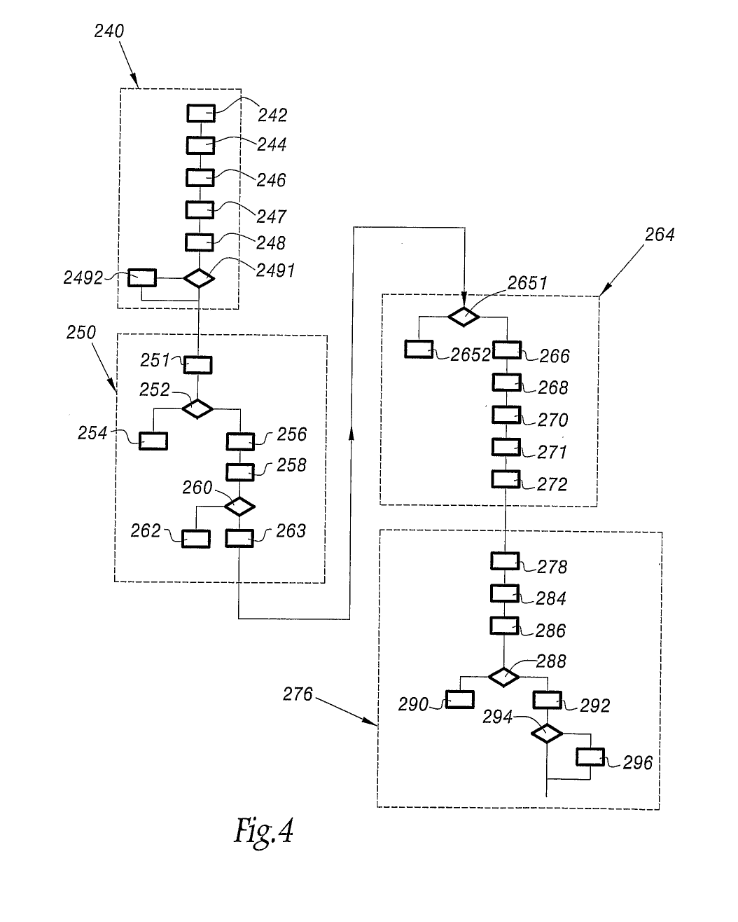

FIG. 4 is a flowchart of a method of exchanging encrypted messages in a descrambler unit and a removable cryptographic unit of the receiver device from FIG. 1.

FIG. 1 represents a system 2 for sending and receiving scrambled multimedia signals, for example audiovisual signals or multimedia programmes. The system 2 includes a sender 4 adapted to broadcast simultaneously to a plurality of receiver devices multimedia signals scrambled using a control word. This sender 4 is also adapted to send each of the receiver devices entitlement control messages (ECM) containing the control word to be used to descramble the multimedia signals and entitlement management messages (EMM) containing information for managing user access rights.

To simplify FIG. 1, only one receiver device 6 is shown. Only the details of the device 6 necessary for understanding the invention are described here.

The device 6 is formed of three entities, for example, namely:

a decoder 10 with an antenna 12 for receiving scrambled multimedia signals broadcast by the sender 4 and for decoding them after descrambling them;

a unit 14 for descrambling received multimedia signals; and

a removable cryptographic unit, such as a removable security processor 16, adapted to decrypt the control word contained in an ECM.

Below, references to a control word apply to one or more control words of an ECM.

The decoder 10 is also connected to a display unit 20 such as a television set on which multimedia signals descrambled by the unit 14 are displayed.

The unit 14 takes the form of a removable PCMCIA (Personal Computer Memory Card International Association) card, for example, intended to be inserted into the decoder 10 in accordance with the EN 50221 standard “Common Interface Specification for Conditional Access and Other Digital Video Broadcasting Decoder Applications”. To this end, the decoder 10 and the unit 14 each have connectors for mechanically coupling and uncoupling the unit 14 and the decoder 10. The unit 14 includes a descrambler 22 adapted to descramble multimedia signals scrambled by means of the control word.

The unit 14 includes information storage means, shown here as a memory 26, and an encryption and decryption module 28.

The module 28 is adapted to encrypt and decrypt all or part of each message exchanged between the unit 14 and the processor 16 using a session key Kₛ. The encryption and decryption algorithms used are DES (Data Encryption Standard) algorithms, for example.

The memory 26 contains three cryptographic certificates C_{1T}, C_{2T}, and C_{3T}. The certificate C_{1T} includes:

a public key K_{T1pu};

a certificate expiry date; and

a signature S_{ign1}K_{T1pr} produced from data contained in the certificate C_{1T} using a private key K_{T1pr} corresponding to the public key K_{T1pu} (self-signed certificate).

The certificate C_{2T} includes:

a public key K_{T2pu};

a certificate expiry date; and

a signature S_{ign2}K_{T1pr} produced from data contained in the certificate C_{2T} using a private key K_{T1pr}.

Finally, the certificate C_{3T} includes a public key K_{T3pu}, an expiry date, and a signature S_{ign3}K_{T2pr} produced from the data contained in the certificate C_{3T} using a private key K_{T2pr} corresponding to the public key K_{T2pu}.

The memory 26 also contains a private key K_{T3pr}, a threshold S₁, a preloaded session key Kₛₚ, a large prime number n, and a number g belonging to the set Zₙ, which is the set of integers from 0 to n−1.

The private key K_{T3pr} corresponds to the public key K_{T3pu}.

All data described here as being contained in the memory 26 is stored in the memory 26 during fabrication of the unit 14, for example. The unit 14 also includes a counter 30 for counting messages exchanged between the unit 14 and the processor 16, a register 32 containing the current date, and a calculator 34 adapted to establish a redundancy code for a message sent to the processor 16 and to verify the redundancy code of a received message.

The security processor 16 takes the form of a microchip card adapted to be inserted into the descrambler unit 14, for example. To this end, the unit 14 and the processor 16 each include connection interfaces such as mechanical connectors for coupling and uncoupling the unit 14 and the processor 16.

This security processor includes a module 52 adapted to encrypt and decrypt all or part of a message exchanged between the processor 16 and the unit 14 using encryption and decryption algorithms compatible with those used by the module 28.

The processor 16 also includes a module 50 for extracting and decrypting a control word contained in an ECM.

The processor 16 further includes:

a calculator 54 adapted to calculate the redundancy code of a message sent to the unit 14 and to verify the redundancy code of a message received from the unit 14;

an internal counter 56 for counting messages exchanged between the unit 14 and the processor 16;

an internal register 58 containing the current date; and

information storage means shown as a memory 60.

The memory 60 contains three cryptographic certificates C_{1c}, C_{2c}, and C_{3c}.

The certificate C_{1c} includes the public key K_{C1pu}, a certificate expiry date, and a signature S_{ign1}K_{C1pr} produced from the content of the certificate C_{1c} using a private key K_{C1pr}. The key K_{C1pr} corresponds to the public key K_{C1pu} (self-signed certificate).

The certificate C_{2c} includes a public key K_{C2pu}, an expiry date of the certificate C_{2c}, and a signature S_{ign2}K_{C1pr} produced from the content of the certificate C_{2c} using the private key K_{C1pr}.

The certificate C_{3c} contains the public key K_{C3pu}, an expiry date of the certificate C_{3c}, and a signature S_{ign3}K_{C2pr}. The signature S_{ign3}K_{C2pr} is produced from the content of the certificate C_{3c} using the private key K_{C2pr}.

The memory 60 also contains a private key K_{C3pr}, the preloaded session key Kₛₚ, the threshold S₂ higher than the threshold S₁, the prime number n, and the number g. The private key K_{C3pr} corresponds to the public key K_{C3pu}. The key Kₛₚ preloaded into the memory 60 has the same value as the key Kₛₚ loaded into the memory 26.

The data contained in the memory 60 described above is stored during fabrication of the processor 16, for example.

The processor 16 can exchange messages with the unit 14 only when it is inserted into the unit 14.

Similarly, the unit 14 can send a descrambled multimedia signal to the decoder 10 only when the unit 14 is inserted into the decoder 10.

The sender 4 broadcasts multimedia signals scrambled using a control word that is sent in encrypted form to the device 6 in an ECM.

The device 6 receives the scrambled multimedia signals and the ECM, together with entitlement management messages (EMM) for managing access rights and system security. ECM and EMM are sent by the unit 14 to the processor 16. In particular, ECM are sent to the module 50 of the processor 16, which extracts the control word from an ECM and decrypts it.

The control word decrypted in this way is then sent to the unit 14, where it is fed to the descrambler 22. The descrambler 22 uses the decrypted control word to descramble the received scrambled multimedia signals. The descrambled multimedia signals are then sent to the decoder 10, which decodes them and sends them to the display unit 20 for presentation to a user.

In the device 6, messages exchanged between the unit 14 and the processor 16 are encrypted using the session Kₛ. Depending on the embodiment, each message is encrypted this way either in its entirety or partially. With partial encryption of each message, the control word extracted from the ECM and sent from the processor 16 to the unit 14 constitutes the part systematically encrypted by the module 52.

The session key Kₛ is known only to the processor 16 and to the unit 14. In particular, the key Kₛ differs from one receiver device to another. Accordingly, messages exchanged between the processor 16 and the unit 14 are made difficult to intercept and unusable by another receiver device.

The operation of the device 6 is described next with reference to the flowcharts of FIGS. 2, 3A, 3B, and 4.

FIG. 2 represents a method of establishing certificates C_{1T}, C_{2T}, C_{3T}, C_{1c}, C_{2c}, and C_{3c}.

Initially, a trusted authority is provided with the certificate C_{1T}, the certificate C_{1c}, and the private keys K_{T1pr} and K_{C1pr}. The trusted authority is the entity responsible for guaranteeing reliable exchange of messages between the unit 14 and the processor 16, for example.

During a step 80, the trusted authority chooses a private/public key pair K_{T2pr}/K_{T2pu} for a descrambler unit manufacturer.

Then, during a step 82, the authority constructs the certificate C_{2T} for that manufacturer and signs it using its private key K_{T1pr}.

During a step 84, the certificate C_{2T} constructed during the step 82, the certificate C_{1T}, and the private key K_{T2pr} are sent to the descrambler unit manufacturer.

Steps 80 to 84 are repeated for each descrambler unit manufacturer. During the step 80, each descrambler unit manufacturer is assigned a private/public key pair K_{T2pr}/K_{T2pu} different from that assigned to other manufacturers.

Then, during a step 86, each manufacturer chooses a private/public key pair K_{T3pr}/K_{T3pu} for each descrambler unit manufactured. The private/public key pair K_{T3pr}/K_{T3pu} is preferably unique to each descrambler unit manufactured.

Then, during a step 88, the manufacturer constructs the certificate C_{3T} of the descrambler unit and signs it using the private key K_{T2pr} that it received during the step 84.

Finally, during a step 90, the certificates C_{1T}, C_{2T}, C_{3T}, and the private key K_{T3pr} are stored in the memory 26 of the unit 14.

During the step 90, the preloaded session key Kₛₚ and the numbers n and g are also stored in the memory 26.

In parallel with the steps 80 to 84, during steps 92 to 96, the trusted authority carries out the same tasks as for the descrambler unit manufacturers, but this time for the security processor manufacturers. For example, the steps 92, 94, and 96 are identical to the steps 80, 82, and 84, respectively, except that the suffix “T” in the certificates C_{1T} and C_{2T} and in the keys K_{T1pr}, K_{T2pr}, K_{T2pu} is replaced by the suffix “C”.

Similarly, in parallel with the steps 86 to 90, during steps 98 to 102, the security processor manufacturer carries out the same tasks as for the descrambler unit manufacturers. For example, the steps 98, 100, and 102 are identical to the steps 86, 88, and 90, respectively, except that the suffix “T” in the terms C_{1T}, C_{2T}, C_{3T}, K_{T2pr}, K_{T3pr}, K_{T3pu} is replaced by the suffix “C”.

This stacking of three levels of certificates guarantees that only a manufacturer approved by the trusted authority can manufacture a descrambler unit or a security processor able to work in the device 6. For example, a non-approved descrambler unit 14 manufacturer cannot generate a certificate C_{3T} signed by a private key K_{T2pr} corresponding to a valid certificate C_{2T}.

Once it has been manufactured, the unit 14 is inserted into the decoder 10 and the processor 16 is inserted into the unit 14 in order to descramble signals sent by the sender 4.

The method of FIGS. 3A and 3B for establishing a common symmetrical session key is then executed.

Initially, during a phase 110, the processor 16 and the unit 14 authenticate each other by exchanging their cryptographic certificates.

More precisely, during a step 112, the unit 14 sends the certificate C_{1T} to the processor 16. During a step 114, the processor 16 extracts the public key K_{T1pu} from the certificate C_{1T}. Then, during a step 116, the processor 16 verifies that the certificate C_{1T} received is valid. During the step 116, it verifies the signature of the certificate C_{1T} using the public key K_{T1pu} and compares the expiry date contained in the certificate to the current date contained in the register 58.

If the certificate is signed incorrectly or has expired (i.e. if the current date is after the expiry date), then, during a step 118, the processor 16 sends the unit 14 a message commanding stopping of the unit 14 and is stopped itself. The process of establishing a session key is therefore interrupted immediately.

Otherwise, i.e. if the certificate C_{1T} is valid, the processor 16 sends the certificate C_{1C} to the unit 14 during a step 120.

During a step 122, the unit 14 extracts the public key K_{C1u} from the certificate C_{1C} and then, during a step 124, verifies the validity of the certificate C_{1C} received.

During the step 124, the unit 14 verifies the signature of the certificate C_{1C} and compares the expiry date contained in that certificate to the current date contained in the register 32.

If the certificate C_{1C} is signed incorrectly or has expired, then, during a step 126, the unit 14 sends the processor 16 a message to command stopping of the processor 16 and the unit 14 is stopped itself. Thus no other step of establishing the session key is executed.

Otherwise, i.e. if the certificate C_{1C} received is valid, then, during a step 128, the unit 14 and the processor 16 exchange and verify each other's certificates C_{2C} and C_{2T}. To this end, during the step 128, the steps 112 to 126 are repeated, replacing the terms C_{1T}, C_{1C}, K_{T1pu}, K_{C1pu} by the terms C_{2T}, C_{2C}, K_{T2pu}, K_{C2pu}, respectively.

At the end of the step 128, if it has been established that one of the certificates exchanged is signed incorrectly or has expired, the unit 14 (respectively the processor 16), in a step 129 equivalent to the step 126 (respectively 118), sends the processor 16 (respectively the unit 14) a message commanding stopping of the processor 16 (respectively the unit 14) and is stopped itself. Otherwise, if at the end of the step 128 it has been established that the certificates C_{2T} and C_{2C} are valid, then, during a step 130, the unit 14 and the processor 16 exchange each other's certificates C_{3T} and C_{3C} and verify their validity. For example, during the step 130, the steps 112 to 126 are repeated, replacing the terms C_{1T}, C_{1C}, K_{T1pu}, K_{C1pu} by the terms C_{3T}, C_{3C}, K_{T3pu}, K_{C3pu}, respectively.

At the end of the step 130, if it has been established that one of the certificates exchanged is signed incorrectly or has expired, the unit 14 (respectively the processor 16), in a step 131 equivalent to the step 126 (respectively 118), sends the processor 16 (respectively the unit 14) a message commanding stopping of the processor 16 (respectively the unit 14) and is stopped itself. Otherwise, if at the end of the step 130 it has been established that the certificates C_{3T} and C_{3C} are valid, then a phase 150 of constructing the new session key Kₛ is triggered, as all the certificates exchanged during the phase 110 are valid.

It is therefore clear that by means of this phase 110 of mutual certificate verification, a unit 14 can work correctly with a processor 16 only if the unit 14 and the processor 16 have been manufactured by approved manufacturers.

Moreover, at the end of the phase 110, the unit 14 has in particular the certified public key K_{C3pu} and the processor 16 has available in particular the certified public key K_{T3pu}.

Messages for carrying out the phase 110 of mutual certificate verification are exchanged between the unit 14 and the processor 16 in a form encrypted using the current session key, as are messages exchanged by the unit 14 and the processor 16 for carrying out the phase 150 of constructing the new session key.

At the beginning of the phase 150, during a step 152, the unit 14 draws a random number A and sends it to the processor 16 during a step 154.

During a step 156, the processor 16 receives the message containing the number A and extracts that number.

During a step 158, the processor 16 draws a random number u and then, during a step 160, constructs a term X using the following equation:

X=g^{u}mod n (1)

where:

g and n are numbers stored in the memory 60;

“mod” indicates that the exponentiation g^{u} is effected modulo n.

Then, during a step 162, the processor 16 combines the term X and the random number A in a predefined way and signs the result using its private key K_{C3pr}. One example of this kind of combination is a concatenation of the term X and the random number A.

During a step 164, the processor 16 draws a random number B.

After that, during a step 166, a message containing the random number B, the term X, the random number A, and the signature of X and of A is sent to the unit 14.

When it receives this message, during a step 168, the unit 14 verifies the signature of the term X and of the random number A using the public key K_{C3pu}.

If the signature is incorrect, during a step 170, the unit 14 commands stopping of the processor 16 and is then itself stopped.

Otherwise, i.e. if the signature of the term X and of the random number A is correct, then, during a step 172, the unit 14 extracts the term X and the random number A from the received message.

Then, during a step 174, the unit 14 compares the number A received to the number A sent during the step 154.

If the random numbers received and sent are different, then the unit 14 stops during a step 176.

Otherwise the process continues with a step 178 during which the unit 14 extracts the random number B from the received message and draws a random number v. Then, during a step 180, the unit 14 constructs a term Y using the following equation:

Y=g^{v}mod n (2)

During a step 182, the unit 14 combines the term Y and the random number B in a predefined way, such as concatenation, and signs the result using the private key K_{T3pr}.

During a step 184, the unit 14 sends the processor 16 a message containing the term Y, the random number B, and the signature of Y and of B.

During a step 190, the processor 16 receives the message and, during a step 192, verifies the signature of the term Y and of the random number B using the public key K_{T3pu}.

If the signature is incorrect, during a step 194, the processor 16 commands stopping of the unit 14 and is then itself stopped.

Otherwise, during a step 196, the processor 16 extracts the term Y and the random number B from the received message.

Then, during a step 198, the processor 16 compares the random number B received to the random number B sent during the step 166. If these random numbers are not equal, then the processor 16 is stopped during a step 200.

Otherwise, during steps 204 and 214, the processor 16 and the unit 14 each proceed to the construction of the new session key Kₛ.

During the step 204, the processor 16 constructs the new session key using the following equation:

Kₛ=Y^{u}mod n (3)

Then, during a step 206, the processor verifies if the session key constructed during the step 204 is included in a list of weak keys or semi-weak keys for the encryption and decryption algorithms used. With the DES algorithm, the list of weak keys or semi-weak keys is described in section 12.3 of the Bruce Schneier book.

If the session key constructed is included in such a list of weak or semi-weak keys, then the processor 16 retains the current session key for encrypting and decrypting messages exchanged with the unit 14.

If the session key constructed is not included in this list of weak or semi-weak keys, then, during a step 208, the processor 16 reinitializes its counter 56 and then, during a step 210, replaces the current session key by the new session key used thereafter to encrypt and decrypt messages exchanged with the unit 14.

In parallel with the steps 204 to 210, during the step 214, the unit 14 constructs the new session key Kₛ using the following equation:

Kₛ=X^{v}mod n (4)

The unit 14 then proceeds to a verification step 216 to find out if the session key constructed in the step 214 is included in a list of weak or semi-weak keys for the encryption and decryption algorithms used. The step 216 is necessarily designed to be consistent with the step 206.

If the session key constructed is included in such a list of weak or semi-weak keys, during a step 218, the unit 14 immediately triggers the process of establishing a new session key by returning to the step 112.

If the session key constructed is not a weak or semi-weak key, during a step 220, the unit 14 reinitializes its counter 30 and then, during a step 222, replaces the current session key with the new session key that has been constructed. Thus subsequent messages exchanged between the unit 14 and the processor 16 are encrypted using the new session key.

It should be noted that, by means of the steps 168 and 192, an interceptor attack is detected immediately, which immediately stops construction of the session key and disables further exchanges. Similarly, by means of the steps 174 and 198, a replay attack is detected immediately, which immediately stops construction of the session key and disables further exchanges.

FIG. 4 shows how messages exchanged between the unit 14 and the processor 16 are constructed and encrypted.

This process begins in the unit 14, for example, with a phase 240 of the unit 14 sending the processor 16 a message M_{T}.

At the start of the phase 240, during a step 242, the counter 30 is incremented by one predetermined step.

Then, during a step 244, the calculator 34 calculates the redundancy code R_{T} of the message M_{T}. That redundancy code is the result of a cryptographic algorithm, such as a hashing function, that is applied to the message M_{T} and its parameters are set by the current session key and by the current value of the message counter 30. This redundancy code enables the processor 16 to verify the integrity of the received message.

Then, during a step 246, the message M_{T} is encrypted using the current session key Kₛ to obtain the cryptogram M_{T}*.

During a step 247 a message M_{RT} is constructed containing the cryptogram M_{T}* and the redundancy code R_{T}.

The message M_{RT} is then sent to the processor 16 during a step 248.

During a step 2491, provided that no session key change procedure is in progress, the unit 14 compares the value of the message counter 30 to the threshold S₁. If that threshold has been reached or passed, the unit 14 stores during a step 2492 the necessity to activate a session key change procedure to be carried out in accordance with the method of FIGS. 3A and 3B. This key change procedure is triggered automatically by the unit 14, in particular after the message M_{RT} has been processed by the processor 16, so as not to interrupt the processing in progress. Messages exchanged during the session key change procedure are processed in accordance with the FIG. 4 method.

The processor 16 then proceeds to a phase 250 of receiving the message M_{RT}.

At the start of the phase 250, during a step 251, the processor 16 receives the message M_{RT} sent by the unit 14.

Then, during a step 252, the processor 16 compares the current value of the counter 56 to the threshold S₂.

If the value of the counter 56 has reached or passed the threshold S₂, then the processor 16 stops, during a step 254.

Otherwise, during a step 256, the counter 56 is incremented by one increment.

The increment of the counter 30 of the unit 14 and of the counter 56 of the processor 16 can be any increment, for example 1, but they must be the same so that the counters 30 and 56 are synchronized, i.e. so that their values are identical before the steps of verifying the redundancy code. It should also be noted that synchronizing the counters 30 and 56 requires no explicit exchange of counter values the between the unit 14 and the processor 16.

Then, during a step 258, the cryptogram M_{T}* is extracted from the message M_{RT} received and then decrypted by the module 52 using the current session key to obtain the message M_{T}.

During a step 260, the calculator 54 verifies the redundancy code R_{T} contained in the received message M_{RT}. To this end, it calculates the redundancy code R_{T}′ of the message M_{T} using the current session key and the current value of the counter 56 in the same way as the unit 14 did this in the step 244.

If the reconstructed redundancy code R_{T}′ does not match the code R_{T} contained in the received message, then the processor 16 is stopped during a step 262.

Otherwise, the processor 16 processes the received message M_{T} during a step 263.

The processor 16 can equally proceed to a phase 264 of sending a message M_{C} to the unit 14. At the start of the phase 264, in a step 2651, the processor 16 tests if the counter 56 has reached or passed the threshold S₂. If so, it is then stopped during a step 2652.

Otherwise, during a step 266, the counter 56 is incremented by one increment. Then, during a step 268, the calculator 54 calculates the redundancy code R_{C} of the message M_{c}. As in the step 244, the parameters of this redundancy code are set by the current session key and the current value of the message counter 56.

During the subsequent step 270, the message M_{c} is encrypted using the session key Kₛ to obtain a cryptogram M_{c}*.

During a step 271 a message M_{RC} is constructed containing the cryptogram M_{c}* and the redundancy code R_{c}. The message M_{RC} is then sent to the unit 14 during a step 272.

The unit 14 then proceeds to a phase 276 of receiving the message sent by the processor 16.

At the start of the phase 276, during a step 278, the unit 14 receives the message sent by the processor 16.

During a step 284, the counter 30 is incremented by one increment. As in the steps 242, 256, and 266, the increment of the counters 30 and 56 can be any increment but they must be the same, to guarantee synchronization of the two counters.

Then, during a step 286, the module 28 extracts the cryptogram M_{c}* from the message received and decrypts it using the current session key Kₛ.

Then, during a step 288, the calculator 34 verifies the redundancy code R_{C} contained in the received message. To this end it calculates the redundancy code R_{c}′ of the message M_{c} using the current session key and the current value of the counter 30 in the same way as the processor 16 during the step 268.

If the reconstructed redundancy code R_{c}′ is different from the received redundancy code R_{c}, then the unit 14 is stopped during a step 290.

Otherwise, the unit 14 processes the decrypted message M_{c} during a step 292.

During a step 294, provided that no session key change procedure is in progress, the unit 14 compares the value of the message counter 30 to the threshold S₁. If that threshold has been reached or passed, the unit 14 then stores during a step 296 the necessity to activate a session key change procedure that is to triggered automatically by the unit 14. The session key change procedure is carried out in accordance with the method of FIGS. 3A and 3B using messages processed in accordance with the FIG. 4 method.

It should be noted that immediately after the first insertion of the processor 16 into the unit 14, the session key used to encrypt the messages exchanged is the prestored key Kₛₚ. This key is used to mask messages exchanged during the first use of the key according to the method of FIGS. 3A and 3B.

Numerous other embodiments of the system 2 and of the methods of FIGS. 2, 3A, 3B, and 4 are possible. For example, the step 162 can be replaced by a signature step during which either only the term X or only the random number A is signed using the private key K_{C3pr}. Similarly, the step 182 can be replaced by a step during which either only the term Y or only the random number B is signed using the key K_{T3pr}. Subsequent steps of the method of FIGS. 3A and 3B are then adapted accordingly.

The certificates C_{1T} and C_{1C} can be replaced by the values of the keys K_{T1pu} and K_{C1pu}, respectively, without any certificate for these public keys being used.

If a response is systematically sent to each message received, it is possible to increment the counters 30 and 56 either only on receiving a message or only on sending a message.

Certificates exchanged between the processor 16 and the unit 14 can contain complementary information enabling each of these units to identify the other unit in accordance with various criteria. Following analysis of this complementary information, one of the units can adopt a specific behavior adapted to the other unit, as described in French Patent Application FR 2 841 714, for example.

The redundancy code transmitted in the messages exchanged can equally be used conjointly with the session key Kₛ to initialize the encryption of messages during the steps 246 and 270 and their decryption during the steps 258 and 286.

Encryption can apply to the combination of the message M_{T} (respectively M_{c}) and its redundancy code. In these circumstances, the steps 246 and 247 (respectively 270 and 271) are permutated. The message M_{T} (respectively M_{c}) and its redundancy code are first combined during the step 247 (respectively 271), after which this combination is encrypted during the step 246 (respectively 270) to obtain the message to be sent. Similarly, during the step 258 (respectively 286), the message received is decrypted and supplies the message M_{T} (respectively M_{c}) and its redundancy code. In these circumstance, initialization of encryption by the redundancy code is not applicable.

If one of the units is stopped following detection of an attempted attack, it is not necessarily for it to request stopping of the other unit before it is stopped itself. For example, stopping the unit is reflected in the absence of a response to a message, and this absence of response could be interpreted by the other unit as a stop command. To this end, the units typically use a timer automatically triggering stopping of the unit in question if it has not received a response to a message in the time counted down by the timer.

The method from FIG. 2 is described in the particular circumstance where the authorities supplied with the certificates C_{2T} and C_{2C} are manufacturers, enabling control of the interworking of terminals or processors manufactured by different manufacturers. Alternatively, different certificates C_{2T} and C_{2C} are assigned to different multimedia operators. In these circumstances, the certificates C_{2T} and C_{2C} are used to control the interworking of the terminals and the processes of different operators.

In another embodiment, the unit 14 is integrated into the decoder 10.

In a further embodiment, the data contained in the memory 26 or 60 can be modified by specific messages, and in particular the certificates can be renewed as a function of their validity periods.

1. A method of establishing a symmetrical session key Kₛ common to a unit for descrambling multimedia signals scrambled using a control word and a removable cryptographic unit adapted to decrypt the control word necessary for descrambling, wherein:
a) a first unit draws (steps 152, 164) a random number (A or B) and sends it to the other unit;
b) the other unit, or second unit, constructs (steps 160, 180) a term α (X or Y) from which the first unit can establish the session key Kₛ from the following equation:
Kₛ=α^{β} mod n
where β is a random number drawn by the first unit and n is a prime number;
the method being wherein:
c) the second unit sends the first unit a message containing the received random number, the term a, and a signature of the random number and/or of the term α produced using a private key K₃ₚᵣ (steps 166, 184); then
d) the first unit verifies the signature using a public key K₃ₚᵤ corresponding to the private key K₃ₚᵣ (steps 168, 192) and compares the random number received to that sent (steps 174, 198); and
e) if the signature is incorrect or if the random number received does not match that sent, then the first unit does not proceed to the subsequent steps for establishing the session key.

2. A method according to claim 1, wherein the steps a) to e) are reiterated a second time with the roles of the first and second units interchanged.

3. A method according to claim 1, wherein before the steps a) to e), the descrambler unit and the removable cryptographic unit exchange with each other (steps 112, 120, 128, 130):
a first public key K₁ₚᵤ;
a first certificate (C_{2T} and C_{2C}) containing a second public key K₂ₚᵤ and signed using a first private key K₁ₚᵣ corresponding to the first public key K₁ₚᵤ; and
a second certificate (C_{3T} and C_{3C}) containing a third public key K₃ₚᵤ and signed using a second private key K₂ₚᵣ corresponding to the second public key K₂ₚᵤ, the third public key K₃ₚᵤ corresponding to the private key K₃ₚᵣ used to effect signing during step c);
and in that the descrambler unit and the removable cryptographic unit each verify the first and second certificates received (steps 128,130) and proceed to the steps a) to e) only if the descrambler unit and the removable cryptographic unit have been able to verify successfully the authenticity of the first and second certificates each of them has received.

4. A method according to claim 1, wherein one or both of the units increments a first internal counter as a function of the number of messages sent to and/or received from the other unit (steps 242, 284) and automatically triggers setting up a new session key if the first counter exceeds a predetermined first threshold (steps 2492, 296).

5. A method according to claim 4, wherein the other unit increments a second internal counter as a function of the same number of messages (steps 256, 266) and automatically causes descrambling of the multimedia signals to be stopped if the second counter exceeds a predetermined second threshold higher than the first threshold (steps 254, 2652).

6. A method according to claim 1, wherein:
each of the units increments an internal counter as a function of the number of messages sent and/or received (steps 242, 256, 266, 284);
one or both of the units adds to each message sent to the other unit a redundancy code calculated as a function of the content of the message to be sent and the current value of its internal counter (steps 247, 271); and
the other unit verifies the accuracy of the message received by comparing the redundancy code added to a redundancy code calculated as a function of the content of the message received and the current value of its own internal counter (steps 260, 288).

7. A unit (14, 16) adapted to be used in a method of establishing a common session key according to claim 1, wherein it is adapted to execute either the steps a), d), and e) or the steps b) and c) of the method according to the above claims of establishing a session key.

8. A unit (14, 16) according to claim 7, wherein it is adapted to exchange with the other unit the first public key and the first and second certificates and to verify the first and second certificates received in order to proceed either to the steps a), d), and e) or to the steps b) and c) only if the authenticity of the first and second certificates received has been verified successfully.

9. A unit (14,16) according to claim 7, wherein it is adapted either to increment a first internal counter (30) as a function of the number of messages sent to and/or received from the other unit and to trigger establishing a new session key if the counter exceeds a predetermined first threshold (S₁) or to increment a second internal counter (56) as a function of the same number of messages and to cause descrambling of the multimedia signals to be stopped if the second counter exceeds a predetermined second threshold (S₂) higher than the first threshold.

10. A unit according to claim 7, wherein it is adapted:
to increment an internal counter (30, 56) as a function of a number of messages sent to and/or received from the other unit; and
either to add to each message sent to the other unit a redundancy code calculated as a function of the content of the message to be sent and the actual value of its internal counter;
or to verify the accuracy of the message received by comparing the redundancy code added to a redundancy code calculated as a function of the content of the message received and of the current value of its own internal counter.

11. A unit according to claim 7, wherein the unit is either a unit (14) for descrambling a multimedia signal scrambled using a control word or a removable cryptographic unit (16) for decrypting the control word necessary for descrambling.
